(19) United States
(12) Patent Application Publication
(10) Pub. No.: US 2020/0052732 A1
(43) Pub. Date: Feb. 13, 2020

(54) BUMPER SYSTEM FOR AN ELECTRONIC DEVICE

(71) Applicant: Dawn Quinlan, Apollo Beach, FL (US)

(72) Inventor: Dawn Quinlan, Apollo Beach, FL (US)

(21) Appl. No.: 16/058,005

(22) Filed: Aug. 8, 2018

(51) Int. Cl. H04B 1/3888

(52) U.S. Cl. CPC H04B 1/3888

(57) ABSTRACT

A bumper protection system for a smartphone includes: a first bumper; a second bumper; a third bumper; and a fourth bumper, wherein each bumper is adapted for attachment to a corner of a smart phone. The first bumper and second bumper preferably extend partially along a top edge of the smartphone. The third bumper and fourth bumper extend partially along a bottom edge of the smartphone. The first bumper and third bumper extend partially along a first side of the smartphone. The second bumper and fourth bumper extend partially along a second side of the smartphone.

### BACKGROUND OF THE INVENTION

### Field of Invention

The present invention relates to a bumper system to protect a small electronic device.

### Description of Related Art

Cell phones are a common form of communications. Cell phones are fully integrated into most people's daily lives, where individuals use the small electronic device for voice, data and entertainment purposes. The typical smart phone is configured in a small, rectangular screen with an integrated touch screen for interface and interaction with the smart phone. The smart phone screen is typically delicate and is subject to damage if dropped inadvertently. As a result, cell phone devices include guards to shield and guard any smart phones from impact to prevent damage thereto. Most of the systems are completely wrapped around the edges of a phone, guarding the phone from damage thereto. However, some of these devices are more effective than others, however further development of protective systems for a smart phone user is needed.

### SUMMARY OF THE INVENTION

The present invention relates to a bumper protection system for a smartphone includes: a first bumper; a second bumper; a third bumper; and a fourth bumper, wherein each bumper is adapted for attachment to a corner of a smart phone. The first bumper and second bumper preferably extend partially along a top edge of the smartphone. The third bumper and fourth bumper extend partially along a bottom edge of the smartphone. The first bumper and third bumper extend partially along a first side of the smartphone. The second bumper and fourth bumper extend partially along a second side of the smartphone.

### BRIEF DESCRIPTION OF DRAWINGS

FIG. 1 depicts a bumper system in accordance with the present invention.

### DETAILED DESCRIPTION

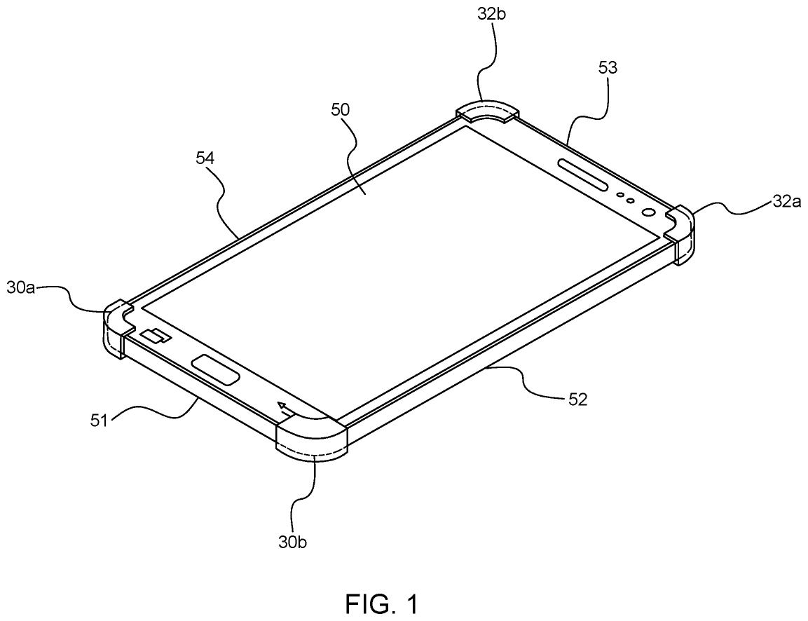

The present invention that relates to the bumper system that installs onto the corners of a conventional smart phone to provide impact resistance. This bumper system includes four bumpers, where one is attached to each corner of the smart phone. FIG. 1 depicts an application of the present invention. In FIG. 1, bumpers 30a, 30b, 32a, 32b are attached to a smart phone 50. The smart phone 50 is depicted as the typical smart phone as used by many consumers. The smart phone 50 has two sides 52, 54, a top edge 53 and a bottom edge 51. The bumpers 30a, 30b are attached to each respective bottom corner of the smart phone 50 as shown. At the top edge 53, bumpers 32a, 32b are attached to each corner of the top edge. The bumpers extend from the corners of the smart phone 50. These bumpers 30a, 30b, 32a, 32b extend from the corners of the smart phone 50 in an abbreviated extension along the edges of a smart phone 50. This abbreviated extension allows a user to have full access to the sides 52, 54 and Top Edge 53 and Bottom Edge 51. The bumpers 30a, 30b, 32a, 32b are also shown as having linear edges, however the bumpers 30a, 30b, 32a, 32b may have a more pronounced shape providing a more extensive impact protection. In one exemplary embodiment, the bumpers 30a, 30b, 32a, 32b may have a bubble shape. This helps when a user is manipulating the smart phone 50. In one particular embodiment, the bumpers may be attached adhesively to the corners and therefore remain in place during use. Other means of attachment are also contemplated such as resilient pressure base upon fit. The bumpers guard against any inadvertent dropping of the smart phone and guard against impact that likely would happen if the phone is dropped. Although the bumper corners are depicted for use on a smartphone the present invention may also be used on other portable electronic devices, such as tablets, ipods or other rectangle devices.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

1. A bumper protection system for a smartphone comprising:
a first bumper, wherein the first bumper affixes over a first corner of the smartphone where the first corner is permanently secured to the smartphone;
a second bumper, wherein the second bumper affixes over a second corner of the smartphone where the second corner is permanently secured to the smartphone;
a third bumper, wherein the third bumper affixes over a third corner of the smartphone where the third corner is permanently secured to the smartphone; and
a fourth bumper, wherein the fourth bumper affixes over a fourth corner of the smartphone where the fourth corner is permanently secured to the smartphone.

2. The bumper protection system according to claim 1, where the first bumper and second bumper extend partially along a top edge of the smartphone.

3. The bumper protection system according to claim 1, where the third bumper and fourth bumper extend partially along a bottom edge of the smartphone.

4. The bumper protection system according to claim 1, where the first bumper and third bumper extend partially along a first side of the smartphone.

5. The bumper protection system according to claim 1, where the second bumper and fourth bumper extend partially along a second side of the smartphone.
